(19) United States
(12) Patent Application Publication
(10) Pub. No.: US 2003/0131149 A1
(43) Pub. Date: Jul. 10, 2003

(54) Installer for driver of network device

(75) Inventor: Takayuki Sugiura, Hyogo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/326,983

(22) Filed: Dec. 24, 2002

(30) Foreign Application Priority Data
Jan. 7, 2002 (JP) 2002-642

(51) Int. Cl. G06F 13/10; G06F 9/00

(52) U.S. Cl. 709/321; 709/327

(57) ABSTRACT

An installer execution file comprises a program operable to effect the step of installing a driver of a particular device connectable to a network in an information processing apparatus connectable to the network, and an area of setting information for the driver. The installer execution file is operable to effect the step of installing the driver, and the step of writing the setting information into the installed driver.

### FIELD OF THE INVENTION

The present invention relates to installing a driver of a network device, and in particular to a structure and preparation of an installer for installing the driver of a device, such as a printer, a scanner and the like, connected to a network, in an information processing apparatus connected to the network.

### BACKGROUND OF THE INVENTION

In order to use, through a client personal computer (PC), a device, such as a printer, a scanner, a file device and the like, connected to a local area network (LAN), it is necessary for a user of the PC connected to the LAN to use an installer to pre-install a driver of the device in the PC. When installing the driver, each user must enter a predetermined device identifier, such as an IP address or a host name of the device, a predetermined device type, such as a device name and a device model identification determined by a manufacturer, and user's selections related to desired functions or property of the device, as setting information in the driver.

However, the user is often unfamiliar with installing the driver software, and may make a mistake in operation. For the purpose of installing the driver on the client PC, it is not efficient to allow each user to enter his or her desired setting information in the driver.

The inventor has recognized that it is advantageous to cause an installer to automatically write predetermined and desired setting information in a device driver. For this purpose, the inventor has recognized that it is necessary to provide the installer with an area of driver setting information, so that a network system administrator can pre-write the predetermined and desired driver setting information in the area.

An object of the present invention is to provide a file structure of an installer for automatically writing setting information in a device driver.

Another object of the invention is to allow driver setting information to be written in an installer for a device driver.

### SUMMARY OF THE INVENTION

In accordance with one aspect of the present invention, an installer execution file (which may be stored on a storage medium) is operable to effect the step of installing a driver of a particular device connectable to a network in an information processing apparatus connectable to the network. The installer execution file comprises an install program, and an area of setting information for the driver.

In accordance with another aspect of the invention, a program (which may be stored on a storage medium) is for use in an information processing apparatus. The program is operable to effect the step of providing an installer execution file, the step of allowing a user to enter setting information for a driver of a network device, the step of incorporating the entered setting information into the installer execution file, and the step of storing the installer execution file including the setting information in a storage device.

In accordance with a further aspect of the invention, an installer execution file (which may be stored on a storage medium) is for use in an information processing apparatus connectable to a network. The installer execution file comprises an area of setting information for a driver of a network device. The installer execution file is operable to effect the step of installing the driver, and the step of writing the setting information in the installed driver.

The installer execution file is operable to further effect the step of determining whether the driver conforms to an operating system currently in operation on the information processing apparatus. The step of installing comprises reading the driver at a storage location included in the setting information.

According to the invention, a file structure of an installer for automatically writing setting information in a device driver is provided, and the driver setting information can be written in an installer for the device driver.

### BRIEF DESCRIPTION OF THE DRAWINGS

FIG. 1 shows a network configuration including client personal computers, a network device and a file server, which are interconnected via a network.

FIG. 2 shows a structure of an execution file of an installer software, in accordance with an embodiment of the present invention.

FIG. 3 shows modification of the structure of the installer execution file of the embodiment shown in FIG. 2.

FIG. 4 shows separate structures of an installer execution file and a driver file, in accordance with another embodiment of the invention.

FIG. 5 shows modification of the structures of the installer execution file and the driver file, in accordance with the embodiment of FIG. 4.

FIGS. 6A and 6B show the installer execution files similar to the installer execution file of FIG. 2.

FIG. 6C shows an installer execution file including a plurality of different drivers.

FIG. 7 shows a flow chart for presetting the installer that is executed by the processor of the PC.

FIGS. 8-10 illustrate respective display screens of entering the information for presetting the installer.

FIG. 11 shows a flow chart for installing the driver software of the device that is executed by the processor of the PC.

FIG. 12 shows a flow chart for reading the installer execution file to be executed that is executed by the processor of the PC.

### DESCRIPTION OF THE PREFERRED EMBODIMENTS

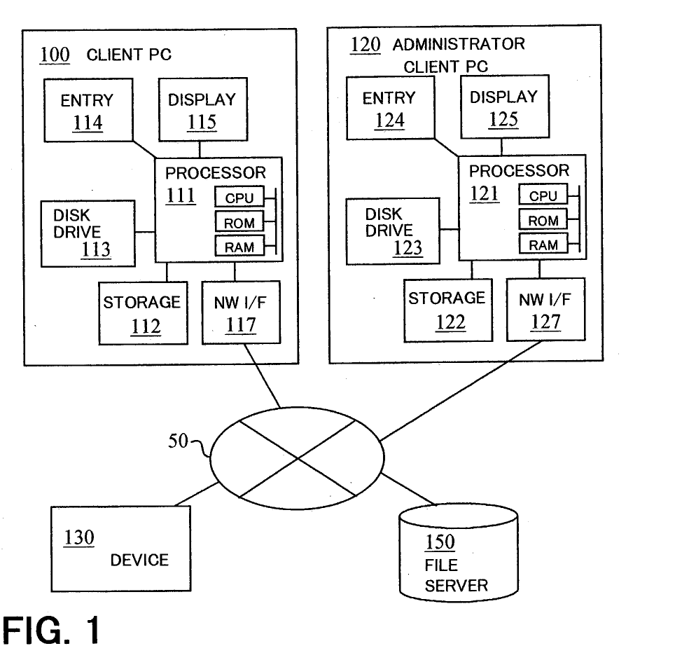

FIG. 1 shows a network configuration including client personal computers (PCs) 100 and 120, a network device 130, such as a printer, a scanner, a digital camera or a file device, and a file server 150, which are interconnected via a network 50 such as a local area network (LAN). The network 50 may have any physical form, and may be a wire LAN, a wireless LAN or an optical fiber LAN, for example. The network 50 may include other client PCs and network devices, which are not shown in the figure.

The client PC 100 includes a processor 111 having a CPU, a ROM and a RAM, a storage device 112, such as a hard disk device having a hard disk and a drive, a disk drive 113, such as a CD drive, an entry or input device 114, such as a keyboard and a mouse, a display device 115, and a network interface 117 connected to the network 50. The storage device 112 stores a specific operating system (OS) and applications for the PC 100.

A client PC 120 for a system administrator, similarly, includes a processor 121 having a CPU, a ROM and a RAM, a storage device 122, such as a hard disk device having a hard disk and a drive for example, a disk drive 123, such as a CD drive, an entry device 124, such as a keyboard and a mouse, a display device 125, and a network interface 127 connected to the network 50. The storage device 122 stores a specific OS and applications for the PC 120.

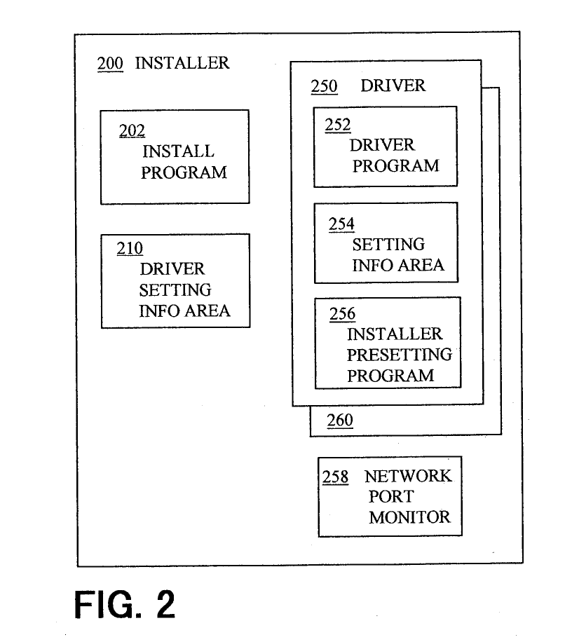

FIG. 2 shows a structure or organization of an execution file 200 of an installer software, in accordance with an embodiment of the invention. The installer execution file 200, which has extension represented typically by “.exe”, includes blocks of a main install program (codes) 202 for installing a device driver software, an area 210 of device driver setting information, device driver software 250 to be installed, and, if necessary, network port monitor software 258, respectively. The driver setting information is incorporated into the installer execution file 200, so that the driver setting information can be easily obtained when the driver is installed. In addition, setting information of the network port monitor is stored as a part of the driver setting information, so that the setting information of the network port monitor can be obtained when the driver is installed.

The driver block 250 includes a main driver program 252 for driving the specific device (130), an area 254 of the driver setting information, and a program 256 for writing the driver setting information in the area 210 in accordance with entry by the administrator user to preset the installer 200.

When an operating system (OS) produced by Microsoft® Corporation is used on the PC and the device 130 is a network printer, it is necessary to install a network port monitor 258 in the PC in addition to the driver 250 for the printer.

The installer 200 may include a plurality of drivers 250, 260, . . . , with respective different functions, of the specific device 130. The install program 202 is used to install the driver 250 and, if necessary, the network port monitor 258. Throughout FIGS. 2-5, similar symbols and numerals indicate similar elements.

Before the driver 250 is installed in the client 100, the administrator operates the client PC 120 to read an unset installer execution file 200 to be executed to install the driver 250, activates the presetting program 256 in the file, and presets the installer execution file 200 using the presetting program 256, i.e., writes predetermined and desired driver setting information in the area 210. The preset installer execution file 200 becomes available to the PC 100 to install the driver 250 in the PC 100.

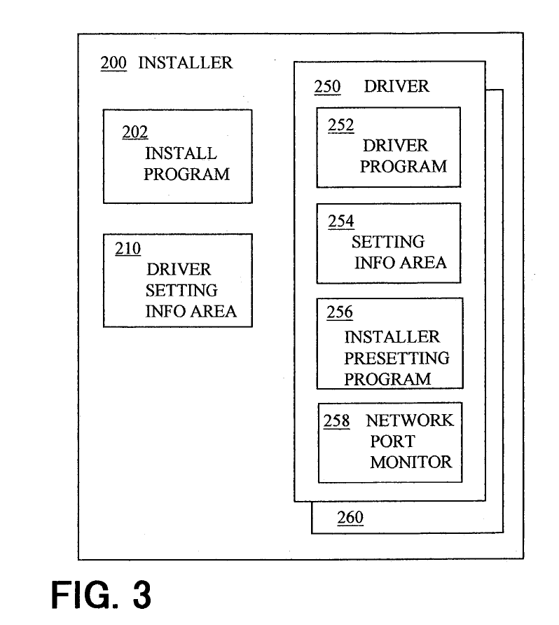

FIG. 3 shows modification of the structure of the installer execution file 200 of the embodiment shown in FIG. 2. In FIG. 3, the network port monitor 258 is a part of the driver 250. When the driver 250 is installed, the network port monitor 258 is also installed.

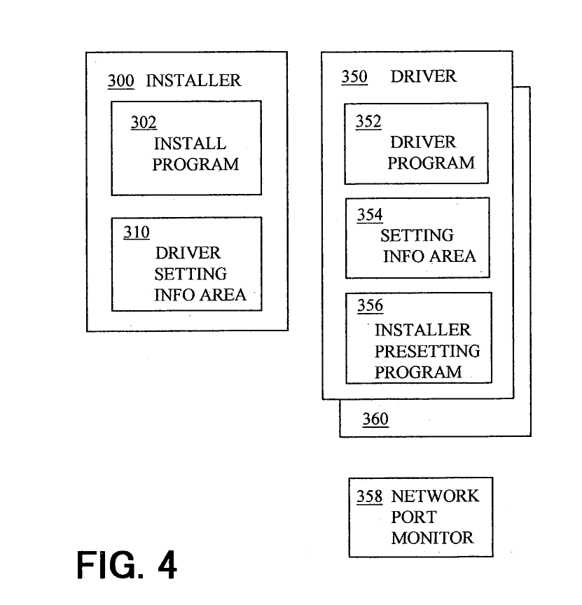

FIG. 4 shows separate structures of an installer execution file 300 and a driver file 350, in accordance with another embodiment of the invention. The installer execution file 300 includes blocks of a main install program (codes) 302 for installing a device driver and an area 310 of device driver setting information.

The driver file 350 includes a main driver program 352 for a specific device (130), an area 354 of driver setting information, and a program 356 for writing the driver setting information into the area 310 in accordance with entry by the administrator to preset the installer 300. A network port monitor 358 may be also used, if necessary.

A host name and a directory of a file system, which stores the driver 350 and, if necessary, the network port monitor 358, are stored in the area 310.

The install program 302 is used to retrieve the driver 350 and, if necessary, the network port monitor 358 from the file system to install them in the PC. The size of the file 300 can be made smaller by separating the installer execution file 300 from the driver file 350.

The install program 302 may install a plurality of drivers 350, 360, . . . with respective different functions, of the specific device 130.

Before the driver 350 is installed in the client 100, the administrator operates the PC 120 to read an unset installer execution file 300 to be executed to install the driver 350, activates the presetting program 356 in the file, and presets the installer execution file 300, i.e., writes predetermined and desired driver setting information in the area 310. The preset installer execution file 300 becomes available to the PC 100 to install the driver 350 in the PC 100.

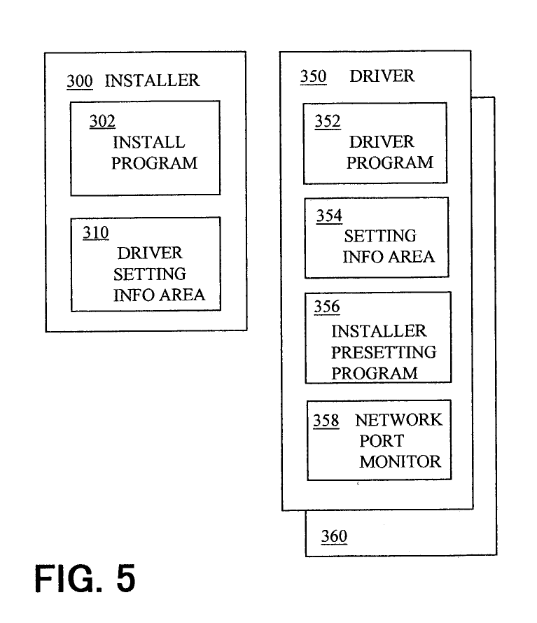

FIG. 5 shows modification of the structures of the installer execution file 300 and the driver file 350, in accordance with the embodiment of FIG. 4. In FIG. 5, the network port monitor 358 is a part of the driver 350. When the driver 350 is installed, the network port monitor 358 is also installed.

In order to preset the installer execution file 200 of FIGS. 2 and 3, the administrator operates the PC 120 to read the installer execution file 200 into the memory area of the RAM, by inserting a disk, such as a CD-ROM, storing the file 200 into the drive 123 or by accessing a memory area of the file server 150 storing the file 200. The installer execution file 200 is activated on the processor 121 in response to the read-in, in a well-known manner, to install the driver block 250.

In order to preset the installer execution file 300 of FIGS. 4 and 5, the administrator operates the PC 120 to read the installer execution file 300 into the RAM area, by inserting a disk, such as a CD-ROM, storing the file 300 into the drive 123 or by accessing a memory area of the file server 150 storing the file 300. The installer execution file 300 is activated on the processor 121 in response to the read-in, in a well-known manner, to read the driver file 350 stored in a predetermined area of the CD-ROM or the file server 150 into the RAM area to install it.

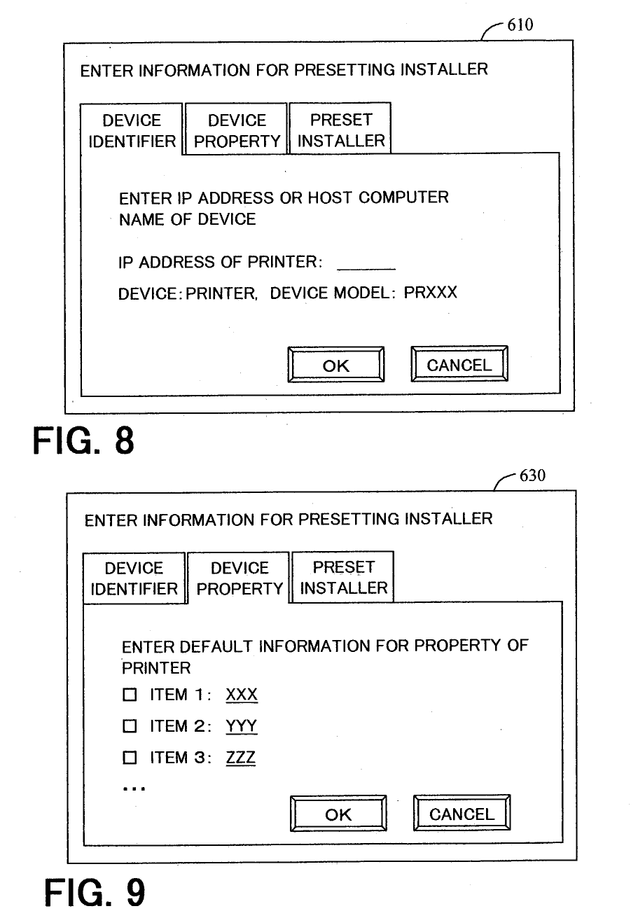

FIG. 7 shows a flow chart for presetting the installer 200 or 300 that is executed by the processor 121 of the PC 120. In the PC 120, when the installer execution file 200 or 300 is read in to be executed, if a required setting information has not been written in the setting information area 210 or 310, the install program 202 or 302 installs the driver block 250 or the driver file 350 in the RAM area, and activates the installer presetting program 256 or 356 in it. The processor 121 executes the flow chart of FIG. 7, in accordance with the program 256 or 356.

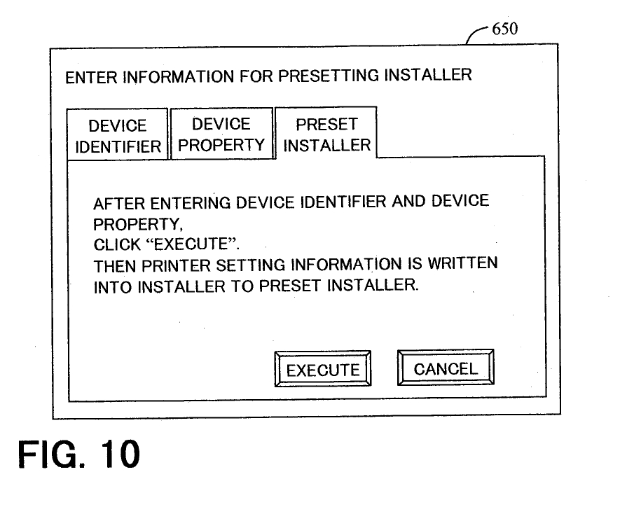

At Step 502 in FIG. 7, the processor 121 displays a display screen of entering information for presetting an installer, on the display device 125. FIGS. 8-10 illustrate respective display screens 610-650 of entering the information for presetting the installer. In an area having a tag “DEVICE IDENTIFIER” on the display screen 610 of FIG. 8, the administrator confirms a device type, such as a device name and a device model identification, and enters an IP address or a host name of the device 230 on the network 50 as a device identifier. A device type may be entered by the administrator, but is preferably preset in the driver setting information area 210 or 310 of the installer execution file 200 or 300 by a manufacturer. The entered device identifier is held in the RAM area by clicking a software button “OK” on the display screen 610.

Next, the administrator enters or selects items of the used functions or property of the device 130 as default information in an area having a tag “DEVICE PROPERTY” on the display screen 630 of FIG. 9. For example, the property of a printer includes items, such as a toner save mode, double/single sided printing, the number of pages printed on a sheet of paper, a picture quality, paper setting, layout setting and the like. For example, the property of a scanner includes items, such as a monochromatic/color mode, a resolution, a picture size, the intensity of a light source, and the like. For example, the property of a file device includes items, such as an account, a group name, access authorization and the like. The entered property items are held in the RAM area by clicking a software button “OK”.

Next, when the administrator clicks a software button “EXECUTE” in an area having a tag “PRESET INSTALLER” on a display screen 650 in FIG. 10, the procedure proceeds to Step 504.

At Step 504, the processor 121 reads the installer execution file 200 or 300 out from the CD-ROM in the drive 123, the file server 150 or the like, and saves it in the RAM area.

At Step 506, the processor 121 writes the driver identifier and the property items held in the RAM area into the driver setting information area 210 or 310 in the saved installer execution file 200 or 300. When the device type is already written in the area 210 or 310, it is not necessary to write it in.

At Step 508, the processor 121 instructs the administrator to enter or select a location or a name of a folder for saving the installer 200 or 300, in which the device identifier and the property items have been written into the setting information area 210 or 310. The administrator may select or designate, for example, the file server 150 or the CD-R in the drive 123. For the file structure shown in FIGS. 4 and 5, the processor 121 further instructs the administrator to enter or select a location for saving the driver 350 and, if necessary, a location for saving the network port monitor 358, such as an IP address or a host name and a directory. The processor 121 writes a saving location of the driver 350 and, if necessary, a saving location of the network port monitor 358 into the driver setting information area of the installer 300.

At Step 510, the processor 121 saves the installer execution file 200 or 300 at the designated storage location, and saves the driver 350 and, if necessary, the network port monitor 358 at the designated storage locations. Thus, the presetting of the installer execution file 200 or 300 is completed.

Thus, the preset or prepared installer execution file 200 or 300 can be attached to electronic mail or downloaded from a Web page.

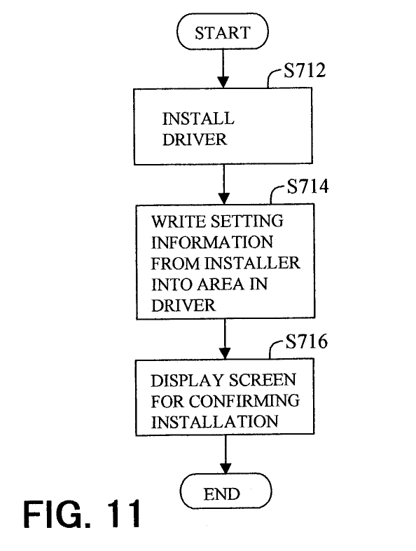

FIG. 11 shows a flow chart for installing the driver software 250 or 350 of the device that is executed by the processor 111 of the PC 100. In order to install the driver for the device 130 in the PC 100, the user of the PC 100 begins to read the preset installer execution file 200 or 300 into the storage device 112, by inserting, for example, a CD-R storing the file 200 or 300 into the disk drive 113, or by accessing the storage area of the file server 150 storing the file 200 or 300.

At Step 712, in response to the reading-in of the preset installer execution file 200 or 300, the processor 111 reads the driver 250 or 350 and, if necessary, the network port monitor 258 which are stored in a CD-R or a predetermined area of the file server 150, into the area of a storage medium of the storage device 112 (for example, a hard disk) in accordance with the install program 202 or 302, to install them. In the installing, the user may be allowed to designate a location or a folder for storing the driver on the PC 100.

At Step 714, the processor 111 writes the setting information from the setting information area 210 or 310 in the installer execution file 200 or 300 as default information or initial valued, into the driver setting information area 254 or 354.

At Step 716, the processor 111 displays a display screen, on the display device 115, for confirming the completion of installation of the driver, when the installation is completed. For example, a name of a printer corresponding to the installed drive is added for display in the printer folder. When the user clicks a software button “CONFIRM”, the installation of the driver 250 or 350 is completed. A device name corresponding to the driver to be installed may be included in the display screen and a software button for changing the property may be displayed. When the button is clicked, a display screen of changing the property may be displayed and the user can set a desired property.

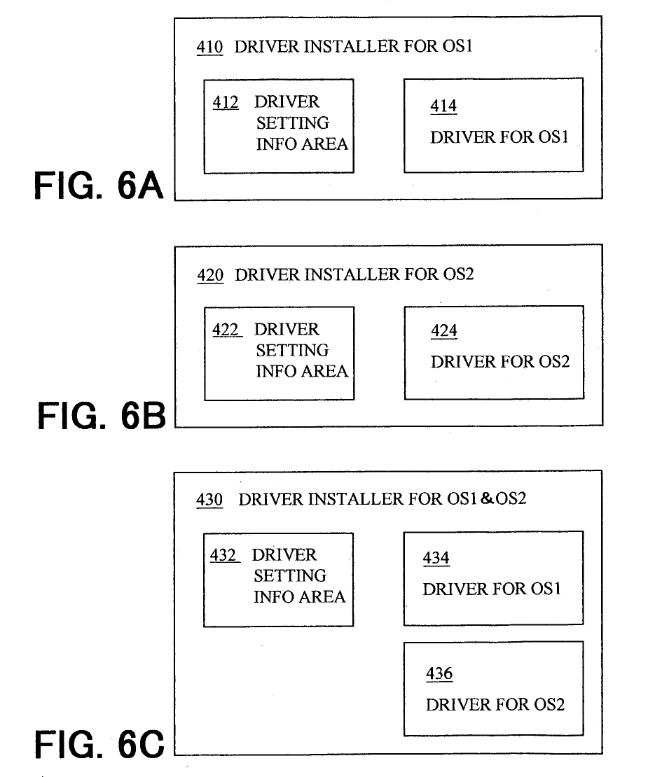

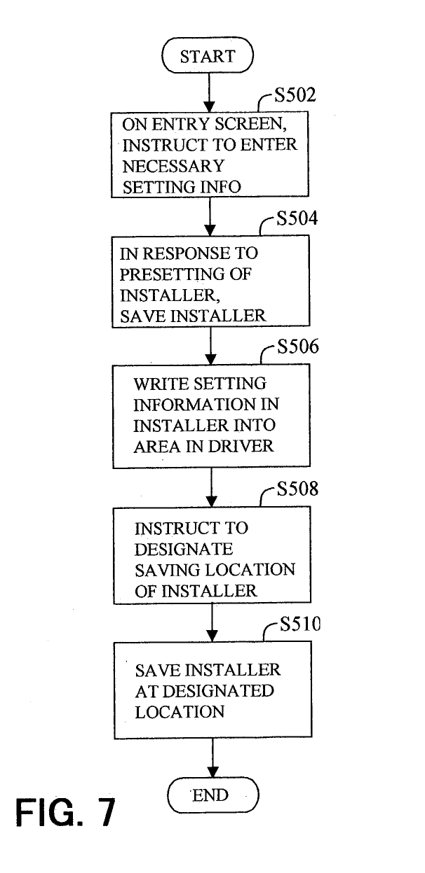

FIGS. 6A and 6B show the installer execution files 410 and 420 similar to the installer execution file 200 of FIG. 2. A file 410 includes a driver setting information area 412 and a device driver 414 which conforms to a first operating system (OS). An installer execution file 420 includes a driver setting information area 422 and a device driver 424 which conforms to a second OS.

FIG. 6C shows an installer execution file 430 including a plurality of different drivers. An installer execution file 430 includes a driver setting information area 432, and device drivers 434 and 436 which conform to the first and second OS's, respectively.

An OS identification, such as an OS name, a version and the like, is pre-stored by the manufacturer in driver setting information areas 412, 422 and 432. The first and second OS's may be those of different versions of the same series. Although not shown, the installer execution files 410, 420 and 430 also include the install program 202 as shown in FIG. 2.

The installer execution files 410, 420 and 430, i.e., the driver setting information areas 412, 422 and 432, are preset by the administrator in the manner as described above. The setting information 432 of the installer execution file 430 is set, using the installer presetting program (256) of the driver 434 or 436 which conforms to the OS in operation on the PC 120 of the administrator.

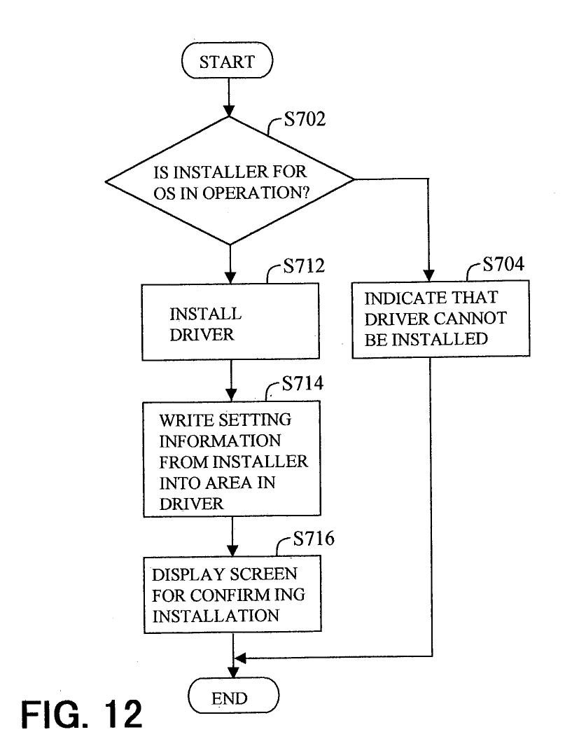

FIG. 12 shows a flow chart for reading the installer execution file 410-430 to be executed that is executed by the processor 111 of the PC 100. In FIG. 12, similar reference numerals indicate similar elements as shown in FIG. 11. At Step 702, when installer execution files 410-430 are read into the PC 100, the processor 111 determines whether the installers 410-430 conform to the OS currently in operation on the PC 100, by comparing the OS identification of the OS in operation with the applicable OS identifications in the setting information areas 412, 422 and 432 of the read-in installer execution file. If it is determined that one of them conforms to the OS, the processor 111 executes Steps 712-716 to install the driver in the PC 100 in the same manner as that in FIG. 11. If it is determined that no installer conforms to the OS in operation, the processor 111 at Step 704 indicates that the driver cannot be installed, on the display screen of the display device 115 of the PC 100, and completes the process.

The above-described embodiments are only typical examples, and their modifications and variations are apparent to those skilled in the art. It should be noted that those skilled in the art can make various modifications to the above-described embodiments without departing from the principle of the invention and the accompanying claims.

What is claimed is:

1. An installer execution file stored on a storage medium, said installer execution file being operable to effect the step of installing a driver of a particular device connectable to a network in an information processing apparatus connectable to the network, said installer execution file comprising:
an install program, and
an area of setting information for said driver.

2. The installer execution file according to claim 1, wherein said program is further operable to effect the step of writing of the setting information into the installed driver.

3. The installer execution file according to claim 1, further comprising said driver.

4. The installer execution file according to claim 3, wherein said driver comprises a program being operable to effect the step of writing of setting information entered by a user into said area.

5. The installer execution file according to claim 1, further comprising said driver and a network port monitor.

6. The installer execution file according to claim 1, wherein the setting information comprises an identification of a location at which said driver is stored.

7. The installer execution file according to claim 1, wherein the setting information comprises an IP address, or a host name and a device identification.

8. The installer execution file according to claim 1, wherein the setting information comprises an identification of an operating system, to which said driver conforms.

9. The installer execution file according to claim 1, further comprising different driver blocks for respective operating systems, wherein the setting information comprises identifications of operating systems, to which said respective driver blocks conform.

10. A program stored on a storage medium for use in an information processing apparatus, said program being operable to effect the steps of:
providing an installer execution file;
allowing a user to enter setting information for a driver of a network device;
incorporating said entered setting information into said installer execution file; and
storing said installer execution file including said setting information in a storage device.

11. The program according to claim 9, wherein said program is included in the driver, and wherein the driver is stored on said storage medium.

12. An installer execution file stored on a storage medium for use in an information processing apparatus connectable to a network, said installer execution file comprising an area of setting information for a driver of a network device, said installer execution file being operable to effect the steps of:
installing said driver, and
writing the setting information into said installed driver.

13. The installer execution file according to claim 12, being operable to further effect the step of determining whether said driver conforms to an operating system currently in operation on said information processing apparatus.

14. The installer execution file according to claim 12, comprising a plurality of driver blocks which conform to different operating systems, wherein the step of installing comprises the step of reading one of said driver blocks that conforms to an operating system currently in operation on said information processing apparatus in accordance with the identifications of said operating systems included in said area.

15. The installer execution file according to claim 12, wherein the step of installing comprises reading said driver at a storage location included in the setting information.

16. In an information processing apparatus, a method for preparing an installer execution file for a driver of a network device, said method comprising the steps of:
providing an installer execution file,
allowing a user to enter setting information for said driver,
incorporating said entered setting information into said installer execution file, and
storing said installer execution file including the setting information into a storage device.

17. In an information processing apparatus connectable to a network, a method for installing a driver of a network device, said method comprising the steps of:
installing said driver using an installer execution file, and
writing setting information for said driver included in said installer execution file into said installed driver.
